(19) United States
(12) Patent Application Publication
(10) Pub. No.: US 2003/0035611 A1
(43) Pub. Date: Feb. 20, 2003

(54) Piezoelectric-optic switch and method of fabrication

(76) Inventor: Youchun Shi, Horseheads, NY (US)

Correspondence Address: CORNING INCORPORATED, SP-TI-3-1, CORNING, NY, 14831

(21) Appl. No.: 09/930,713

(22) Filed: Aug. 15, 2001

(51) Int. Cl. G02B 6/35; G02B 6/26

(52) U.S. Cl. 385/16; 385/15; 385/3

(57) ABSTRACT

A piezoelectric-optic switch and method of fabrication therefor is provided. The switch includes a Mach-Zehnder interferometer having a pair of waveguides disposed in a planar substrate, and strips of piezoelectric material such as PZT disposed on a top surface of the substrate over each of the waveguides. The PZT material is electrophoretically deposited on the substrate to a thickness of between 10 and 20 microns and sintered, resulting in a high density on the order of 8 gm/cm³. The PZT strips deform the planar substrate surrounding the waveguides to an extent necessary to adjust the phase between optical signals transmitted through the waveguides, which in turn allows an optical coupler connected to the output of the waveguides to effect a signal cross-over.

### FIELD OF THE INVENTION

This invention relates to an optical switch having a layer of piezoelectric material electrophoretically deposited on a Mach-Zehnder interferometer, and method of fabrication therefor.

### BACKGROUND OF THE INVENTION

Optical switches are well known in the prior art. Such switches are used in optical fiber communication networks to shift optical signals from one optical fiber to another. Presently, there are three basic types of optical switches, including mechanical, thermo-optic, and electro-optic.

In mechanical optical switches, the switching function is typically controlled by moving a mirror in and out of an optical path. Such switches have the advantages of low insertion losses, low polarization-dependent loss (PDL), low cross talk between two different optical signals, and relatively low cost. However, because of their relatively slow switching speeds on the order of a few milliseconds, their application is limited to the provisioning of light paths within an optical system, such as the reconfiguration of optical cross-connects to support new light paths. In such an application, mechanical switches are replacements for manual fiber patch panels.

Thermo-optic switches are also limited in switching speed on the order of a few milliseconds, but operate in a fundamentally different way than mechanical switches. Such switches are essentially 2×2 integrated-optic Mach-Zehnder interferometers, constructed on waveguide material whose refractive index is a function of temperature. By varying the refractive index on one arm of the interferometer by localized heating, a phase difference in the signal transmitted through the two arms can be generated, resulting in switching an input signal from one output port to another. Such switches are more compact in size than mechanical switches, but are somewhat more expensive to manufacture.

In contrast to mechanical and thermo-optic switches, electro-optic switches have very fast switching times on the order of 1 ns or less. They are formed by a waveguide whose refractive index is changed by the application of a voltage. A commonly used material is lithium niobate (LiNbO₃). The fast switching time allows such switches to be used in protective applications such as the switching of a traffic stream from a primary fiber onto another fiber in the event the primary fiber fails. They may also be used in high speed optical packet-switched networks to switch signals on a packet-by-packet basis. Their fast switching speed also allows them to be used as external modulators to turn on and off the data in front of a laser source. Unfortunately, such electro-optic switches are expensive to manufacture relative to mechanical and thermo-optic switches due to the expense of the lithium niobate material.

The foregoing limitations have prompted a search for a different design of switch which has a short switching time, but yet is relatively low in cost. One such approach has been the use of piezoelectric materials in combination with a fiber-type Mach-Zehnder interferometer as disclosed in a paper entitled “High-Performance Single-Mode Fiber-Optic Switch,” by S. P. Fang and H. F. Taylor, published in Optics Letters, Volume 19, No. 16, dated Aug. 15, 1994. In this particular switch design, a pair of parallel optical fibers are joined at their input and output ends by commercially available 2×2 fiber directional couplers to form a Mach-Zehnder interferometer. A pair of flat, rectangular piezoelectric elements are bonded to each of the parallel optical fibers by a thin layer of cyanoacrylate adhesive. A voltage is selectively applied to each of the piezoelectric elements through nickel electrodes present on the two largest faces of each. Such a switch has a relatively fast switching time on the order of 8 microseconds which, while not as fast as the relatively more expensive lithium niobate electric-optic switches, was still considerably faster than either mechanical or thermo-optic switches.

### SUMMARY OF THE INVENTION

Generally speaking, the invention is both a piezoelectric-optic switch and fabrication method that overcomes the shortcomings associated with the prior art. The switch of the invention comprises an optical interferometer having a pair of integrally formed waveguides disposed in a generally planar substrate, and a high-density layer of piezoelectric material electrophoretically deposited on a surface of the substrate for deforming it in response to an application of electric voltage. The deformation of the substrate changes a phase angle between single-mode optical signals transmitted through the waveguides. The resulting phase difference may be used to effect a switch-over of the optical signals onto different paths.

Preferably, the piezoelectric material is lead zirconate titanate electrophoretically deposited and then sintered onto the substrate to a density of between about 7.0 and 8.0 gm/cm³. The piezoelectric material may be deposited to a thickness of between about 10 and 20 microns, a length between about 3 and 7 centimeters, and a width of about 1.0 millimeters. The strip of PZT materials is preferably sandwiched between a pair of electrodes which may be formed from a vapor deposited layer of conductive material, such an platinum.

The substrate may be a planar, rectangularly shaped piece of silica into which a pair of waveguides and input and output couplers have been formed by the deposition of a suitable dopant atom which increases the index of refraction in the silica. The substrate typically has a thickness of 1.0 millimeters, but thicker substrates are also within the scope of the invention as thicker substrates will also work. Only the deformation of waveguides near the surface of the substrate is necessary. Thus, the distance between PZT strip and waveguide is important but the thickness of the whole substrate is not. The core of each waveguide has a cross-section between about 5 to 10 microns wide. Each waveguide is preferably formed close to the surface of the substrate (i.e., 0.2 mm or less) so that the flexing caused by the piezoelectric material will have a maximum effect.

In the fabrication method of the invention, a planar substrate with two internally disposed linear waveguides as previously described is first provided. Next, a bottom electrode is formed by the vapor deposition of a thin strip of conductive material along or adjacent to each of the linear waveguides. In the preferred method, the thickness of the resulting electrode may be on the order of 0.1 microns. Next, a layer of piezoelectric material such as PZT is electrophoretically deposited over the bottom electrode's layer. The deposited PZT is then sintered, resulting in a high density of between about 7.0 and 8.0 gm/cm³. A top electrode layer is then vapor deposited over a top surface of the resulting strip of PZT material in the same manner as described with respect to the bottom electrode layer.

In operation, an electric potential on the order of 0.1 to 1.0 volts is applied to the PZT strips in order to deform the substrate, which in turn changes the effective index of refraction of the pair of waveguides disposed therein. This adjusts a phase angle difference between optical signals conducted through the waveguides which in turn results in switching over the two signals after they are conducted through the optical coupler located at the output end of the waveguides.

The use of waveguides in a deformable substrate in lieu of optical fibers eliminates the acoustical resonances associated with other designs, and obviates the need for special or additional damping elements that complicate the design of the switch, increase its size and weight, and contribute to the expense of fabrication. The use of electrophoretic deposition to form the piezoelectric material results in a high-density, crack free structure that is well integrated, robust, reliable, and easy and inexpensive to fabricate.

### BRIEF DESCRIPTION OF THE DRAWINGS

FIG. 1 is a plan view of the piezoelectric optic switch of the invention, illustrating the switching circuit used to control the switching operation;

FIG. 2 is a cross-sectional side view of the substrate of the switch 1 illustrated in FIG. 1 along the line 2-2;

FIG. 3 is an enlargement of the area circled in phantom in FIG. 2, and

FIGS. 4A and 4B are plan views of the Mach-Zehnder interferometer portion of the switch, illustrating how the piezoelectric strips thereon selectively warp the substrate of the interferometer in order to effect a cross-over of optical signals.

### DETAILED DESCRIPTION OF THE INVENTION

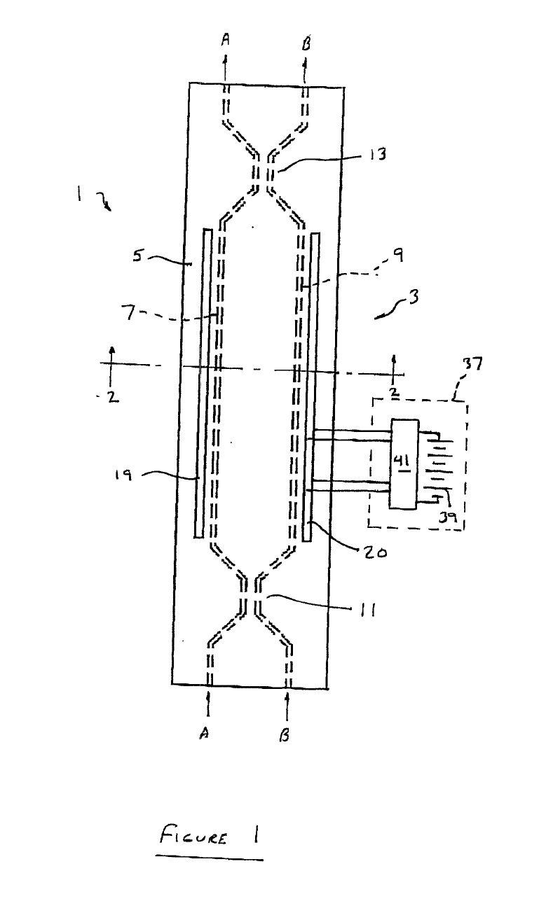

With reference now to FIG. 1, wherein like numerals designate like components throughout all of the several Figures, the piezoelectric optic switch 1 of the invention is a Mach-Zehnder interferometer that includes a flat, rectangular substrate 5 having a pair of parallel, integrally formed waveguides 7, 9, and a pair of integrally formed optical couplers 11 and 13 connected to the waveguides 7, 9 at input and output ends of the substrate 5, respectively. Piezoelectric strips 19 and 20 are mounted on the top surface of the substrate 5 adjacent to the waveguides 7, 9 as shown.

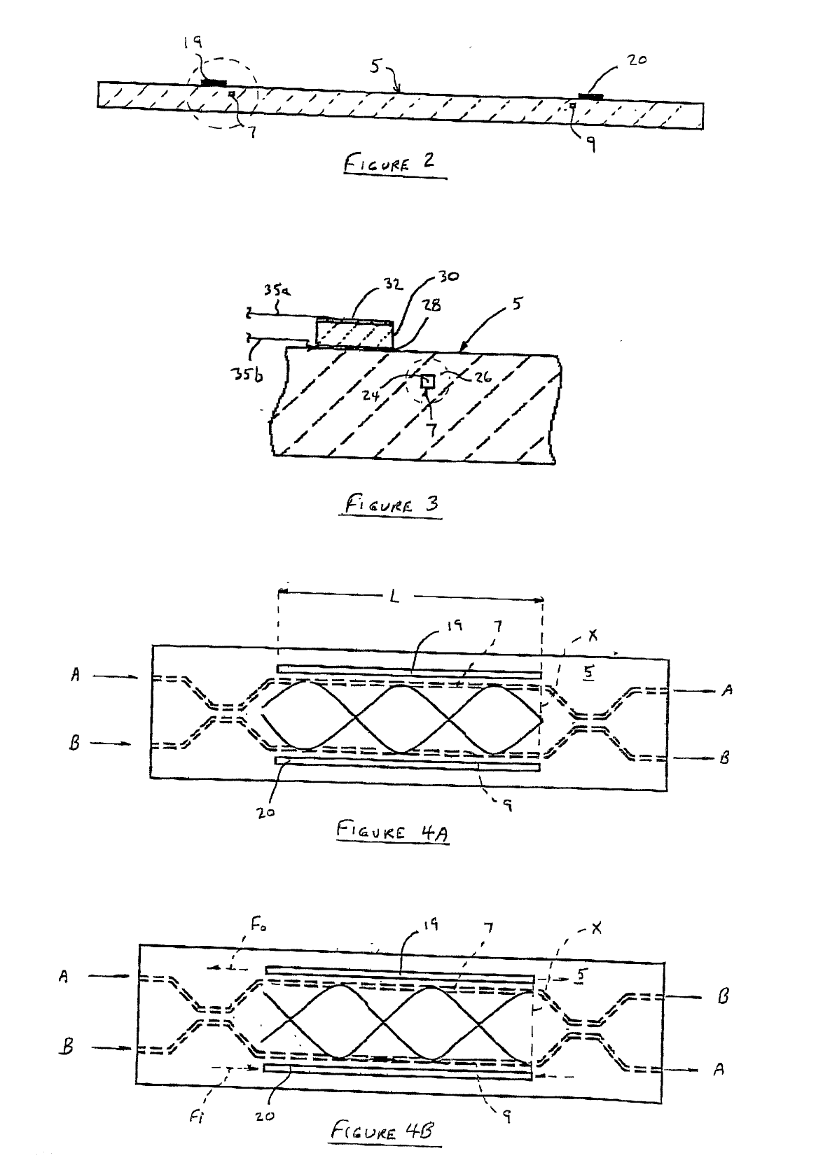

With reference now to FIGS. 2 and 3, the substrate 5 is preferably formed from a light conductive material such as silica. The waveguides 7, 9 are preferably integrally-formed channels that longitudinally extend across the entire length of the substrate 5 formed by the implantation of dopant atoms which increase the index of infraction of the media forming the substrate. Such dopant atoms may be, for example, germanium. While preferably close (i.e., less than 0.2 mm) to the surface of the substrate, the doped channels 24 are dimensioned so that they are surrounded on all sides by undoped portions of the substrate 5, thereby naturally forming a cladding portion 26 in the substrate 5 that surrounds all surfaces of the resulting waveguides 7, 9. The substrate 5 may be 1.0 millimeters in thickness. The waveguides 7, 9 may be square in cross-section, and are only about 5 to 10 microns wide.

The piezoelectric strips 19, 21 each include a bottom electrode 28, a layer 30 of electrophoretically deposited lead zirconate titanate, and a top electrode 32 as best seen in FIG. 3. Electric conductors 35a, b interconnect the top and bottom electrodes 32, 28 to a power circuit 37 schematically illustrated in FIG. 1. The power circuit 37 includes a DC power source 39 and a switching circuit 41 whose function is described in more detail hereinafter.

In the method of fabrication of the switch 1 of the invention, the bottom electrode 28 of each of the piezoelectric strips 19, 21 is first applied onto the upper surface of the substrate 5 by well known vapor deposition techniques in combination with conventional masking techniques. Each of the bottom electrodes 28 need only be deposited to a thickness of 0.10 to 0.20 micrometers, and is formed from a conductive material such as platinum. Next, the layer 30 of PZT material is electrophoretically deposited over the bottom electrodes 28. This is accomplished by immersing the substrate 5 in a solution of dissolved PZT while simultaneously applying a negative charge to the bottom electrodes 28 so that the positively charged ions of PZT accumulate into a layer. Such electrophoretic deposition of PZT is carried out until the thickness of the resulting PZT layers reaches between about 10 and 20 microns. Electrophoretic deposition of the PZT is greatly preferred to chemical-type deposition techniques, such as the use of sol-gel, due to its ability to provide relatively thick and dense layers of PZT in a crack-free manner. The length of the resulting piezoelectric strips 19, 21 is fabricated between about 3 and 7 centimeters, while the width of each of the strips is between 0.07 and 0.15 millimeters, and most preferably 0.10 millimeters. Such dimensioning allows the resulting piezoelectric strips 19, 21 to sufficiently deform at least the surface of the substrate 5 of the interferometer 3 adjacent to waveguides 7, 9 to generate enough interference between optical signals traveling through the waveguides 7, 9 to successfully effect a signal cross-over when such cross-over is desired. After the PZT material has been electrophoretically deposited to the desired thickness, the substrate 5 is removed from the electrolytic solution and sintered at a temperature of preferably 900° C. The sintered layer 30 of PZT will achieve a high density of between 7.0 and 8.0 gm/cm³ which, in combination with the preferred thickness, length, and width, will provide the resulting layer 30 with the power capacity required to easily deform the substrate 5 in order to effect optical switch overs. The top electrode 32 is next manufactured like the bottom electrode 28, i.e., through the vapor deposition of platinum (or some other corrosion-resistant metal) in combination with suitable masking techniques. In the last step of the process, electrical conductors 35a, b are added in order to connect the bottom and top electrodes 28, 32 of each of the piezoelectric strips 19, 21 to the switching circuit 37 illustrated in FIG. 1.

FIGS. 1, 4A and 4B illustrate the operation of the resulting piezoelectric optic switch 1. When no electric potential is applied to either of the piezoelectric strips 19, 21 through the switching circuit 37, the substrate 5 of the interferometer 3 remains planar. In one embodiment, the switch can be manufactured to that there is a phase difference of π/2 between two waveguide arms 7, 9. At the output end of the interferometer, the optical signals A and B are completely crossed from one another. Accordingly, inputs A and B through the waveguides 7 and 9 will transmit straight through the output optical coupler 13 as indicated in FIG. 4A. However, when the switching circuit 37 applies an electric potential (which is preferably on the order of between about 0.1 to 1.0 volts) to each of the piezoelectric strips 19 and 21, the surrounding areas of the strips 19 and 21 of the substrate 5 are deformed. If the switching circuit 37 applies the same potential (but at different polarities) to the piezoelectric strips 19 and 21, strip 19 expands, while strip 21 contracts. Because the PZT material in the strips is securely connected to the upper surface of the substrate 5 via the previously described vapor deposition and electrophoretic techniques, the forces generated by the lengthwise expansion and contraction of the strips 19 and 21 is conducted to the substrate 5, which deforms in response thereto. Such deformation has the effect of slightly changing the effective indices of refraction of the waveguides 7, 9. The change of the effective index of the waveguides 7, 9 adjusts the phase difference in the optical signals being conducted through the waveguides, as indicated in FIG. 4B. The resulting phase difference results in the complete coupling of the optical signals A and B remaining on the same side after coupling through the second coupler 13 in the manner indicated in FIG. 4B. This particular embodiment of the invention requires precise dimensioning of the couplers and waveguides. In another embodiment that does not require such precise dimensioning, first and second voltages V1 and V2 necessary to achieve complete cross-over and complete pass-through (as shown in FIGS. 4A and 4B), are empirically determined. Such an embodiment is operated as previously described, with the exception that the power circuit 37 continuously applies either voltage V1 or V2 to the piezoelectric strips 19 and 21.

While both the switch and its method of fabrication has been described with respect to specific examples in this application, various changes, modifications, and variations in both the switch and the method of fabrication therefor will become evident to persons of ordinary skill in the art. All such modifications, variations, and additions are intended to be encompassed within the scope of this patent, which is limited only by the claims appended hereto.

What is claimed is:

1. A piezoelectric-optic switch comprising:
an optical interferometer having a pair of waveguides disposed in a substrate for conducting first and second optical signals, said substrate being deformable to cause a phase difference between said optical signals, and
piezoelectric material disposed on a surface of said substrate for deforming said substrate in response to an application of electric voltage to selectively adjust said phase difference.

2. The piezoelectric-optic switch defined in claim 1, wherein said piezoelectric material has a density of between about 7.0 and 8.0 gm/cm³.

3. The piezoelectric-optic switch defined in claim 1, further comprising a bottom electrode mounted on a surface of said substrate, and a top electrode, wherein said piezoelectric material is adhered between said bottom and top electrodes.

4. The piezoelectric-optic switch defined in claim 1, wherein said piezoelectric material includes a pair of strip-shaped portions, each of which is disposed along one of said pair of waveguides.

5. The piezoelectric-optic switch defined in claim 2, wherein said piezoelectric material has a thickness of between about 10 and 20 microns.

6. The piezoelectric-optic switch defined in claim 3, wherein said electrodes are formed from a conductive material.

7. The piezoelectric-optic switch defined in claim 4, wherein each of said strip-shaped portions has a length of between about 3 and 7 cm.

8. The piezoelectric-optic switch defined in claim 1, wherein said substrate is planar, and said waveguides are integrally formed within said substrate.

9. The piezoelectric-optic switch defined in claim 8, wherein said substrate is formed from a light-conductive material, and said waveguides are formed from doped channels within said waveguide.

10. A piezoelectric-optic switch comprising:
an optical interferometer having a pair of waveguides integrally formed within a planar substrate for conducting first and second optical signals, said substrate being deformable to adjust sufficient phase difference between said optical signals in an optical coupler to effect a signal cross over from an output of said interferometer, and
a strip of piezoelectric material mounted adjacent to each of said waveguides for deforming said substrate in response to an application of electric voltage to selectively cause said interference-induced signal cross over.

11. The piezoelectric-optic switch defined in claim 10, wherein each of said strips of piezoelectric material is lead zirconate titanate.

12. The piezoelectric-optic switch defined in claim 10, wherein each of said strips of piezoelectric material is electrophoretically deposited onto said substrate to a thickness of between about 10 and 20 microns.

13. The piezoelectric-optic switch defined in claim 10, wherein said piezoelectric material has a density of between about 7.0 and 8.0 gm/cm³.

14. The piezoelectric-optic switch defined in claim 10, further comprising top and bottom electrodes for each of said strips of piezoelectric material.

15. The piezoelectric-optic switch defined in claim 10. wherein said substrate is planar and has a thickness of between about 0.5 and 1.0 mm.

16. A method for fabricating a piezoelectric-optic switch, comprising the steps of:
integrally forming a pair of optical waveguides on a substrate that is sufficiently deformable to adjust phase difference between optical signals transmitted through said waveguides, and
electrophoretically depositing a layer of piezoelectric material on a surface of said substrate of thickness and density sufficient to deform said waveguide to an extent necessary to adjust said phase difference when a voltage is applied to said layer.

17. The method of fabricating a piezoelectric-optic switch defined in claim 16, further comprising the steps of depositing a bottom electrode on said surface of said substrate prior said electrophoretic deposition of said of piezoelectric material.

18. The method of fabricating a piezoelectric-optic switch defined in claim 17, further comprising the step of sintering said deposited layer of piezoelectric material.

19. The method of fabricating a piezoelectric-optic switch defined in claim 17, wherein said piezoelectric material is deposited over said bottom electrode, and further comprising the step of depositing a top electrode over a top surface of said piezoelectric material.

20. The method of fabricating a piezoelectric-optic switch defined in claim 16, wherein said layer is deposited to a thickness of between about 10 and 20 microns.

21. The method of fabricating a piezoelectric-optic switch defined in claim 20, wherein said layer is deposited in the form of strips adjacent to said waveguides.

22. The method of fabricating a piezoelectric-optic switch defined in claim 21, wherein said strips are formed to a length of between about 3 and 7 cm.

23. The method of fabricating a piezoelectric-optic switch defined in claim 16, wherein said piezoelectric material is electrophoretically deposited and sintered to a density of between about 7.0 and 8.0 gm/cm3.

24. The method of fabricating a piezoelectric-optic switch defined in claim 16, wherein said piezoelectric material is lead zirconate titanate.

25. The method of fabricating a piezoelectric-optic switch defined in claim 19, wherein said electrodes are formed by the deposition of a layer of a conductive material about 0.1 to 0.2 micrometers thick.

26. The method of fabricating a piezoelectric-optic switch defined in claim 25, wherein said conductive material includes platinum.
